(19) United States
(12) Patent Application Publication
(10) Pub. No.: US 2026/0359835 A1
(43) Pub. Date: Nov. 12, 2026

(54) PROCESSING CUSTOMER COMMUNICATIONS TO IDENTIFY AND MANAGE CUSTOMER INTENTIONS

(71) Applicant: Infor (US), LLC, Atlanta, GA (US)

(72) Inventors: Steven Keith Levy, Warren, OH (US); Richard Joseph Rider, Cumming, GA (US)

(21) Appl. No.: 19/670,091

(22) Filed: May 7, 2026

Related U.S. Application Data
(60) Provisional application No. 63/801,160, filed on May 7, 2025.

(51) Int. Cl. G06Q 30/015; G06Q 30/0201

(52) U.S. Cl. CPC G06Q 30/015; G06Q 30/02011

(57) ABSTRACT

Disclosed are various embodiments for processing customer communications to identify and manage customer intentions. In one embodiment, a customer communication is received. The customer communication is analyzed using a language model to determine a customer intention expressed in the customer communication. The customer intention is selected from a set of customer intentions. The customer intention is associated with one or more attributes. A proposed response to the customer communication is generated using the language model. The customer communication in association with the determined customer intention, the one or more attributes, and the proposed response are added to a queue for subsequent workflow processing.

### BACKGROUND

Enterprise Resource Planning (ERP) systems are comprehensive software solutions that integrate various business processes within an organization. These systems facilitate the seamless flow of information across different functional areas such as finance, human resources, supply chain management, customer relationship management, and manufacturing. By centralizing data management and automating business processes, ERP systems enhance operational efficiency, improve decision-making, and provide organizations with a unified view of their enterprise data.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIGS. 2 and 3 are flowcharts illustrating examples of functionality implemented as portions of computing environment in the networked environment of FIG. 1 according to various embodiments of the present disclosure.

FIG. 4 is a schematic block diagram that provides one example illustration of a computing environment employed in the networked environment of FIG. 1 according to various embodiments of the present disclosure.

### DETAILED DESCRIPTION

The present disclosure generally relates to processing customer communications to accurately identify and manage customer intentions. Organizations, as part of sales and/or operations, receive numerous communications from customers. These communications may take the form of email messages, text messages, chat logs, voice calls, and so on. Traditionally, such communications were fed into a queue and distributed to customer service representatives. However, depending on staffing and levels of inquiries, customers may have to wait a significant amount of time to have their communications answered. Increasing the number of customer service representatives may be undesirable due to cost and may result in underutilization at non-peak times.

Consequently, organizations are looking to improve efficiencies in handling customer communications. One observation is that different types of communications may have different priorities to the organization. For example, a communication regarding a potential sale may be more important than a communication regarding an order status inquiry. That is to say, the intention of the customer may affect the priority of the communication and how the communication should be handled. Customers communicating regarding purchasing intentions may be treated differently than customers communicating regarding status inquiry intentions.

Interactive voice response (IVR) phone systems attempt to address some of these issues. In IVR phone systems, customers may be presented with a menu list of a predefined set of intentions. The customers may select the most appropriate intention, and then the communication is routed or handled based on the selected intention. Unfortunately, such systems may be constrained by the fixed nature of the menu and may be ill-equipped to handle arbitrary communications from customers.

Various embodiments of the present disclosure introduce generative artificial intelligence (AI) approaches for processing customer communications to accurately identify and manage customer intentions. Specifically, the embodiments may integrate a large language model (LLM) with dynamic learning capabilities, a sophisticated attribute tagging mechanism, and a specialized message queuing system to facilitate efficient workflow management. Various embodiments may be configured with a base set of customer intention types based on the business of the organization, and then the embodiments may be configured to automatically categorize customer communications expressed in arbitrary natural language. The communications may then, based on the identified customer intention, be routed to particular customer service agents for manual workflows or may be routed to automated agents for automated workflows. Both types of workflows may integrate data and functionality available for the organization through the organization's enterprise resource planning (ERP) system.

As one skilled in the art will appreciate in light of this disclosure, certain embodiments may be capable of achieving certain advantages, including some or all of the following: (1) improving the functioning of computers to dynamically respond to customer intentions as expressed in communications; (2) improving the functioning of computers and computer networks by reducing latency involved in responding to customer communications; (3) improving the functioning of computers by automatically incorporating ERP data in proposed responses to customer communications; (4) improving user interfaces of ticketing systems by augmenting the user interfaces to display automatically determined customer intentions in conjunction with customer communications; and so forth. In the following discussion, a general description of the system and its components is provided, followed by a discussion of the operation of the same.

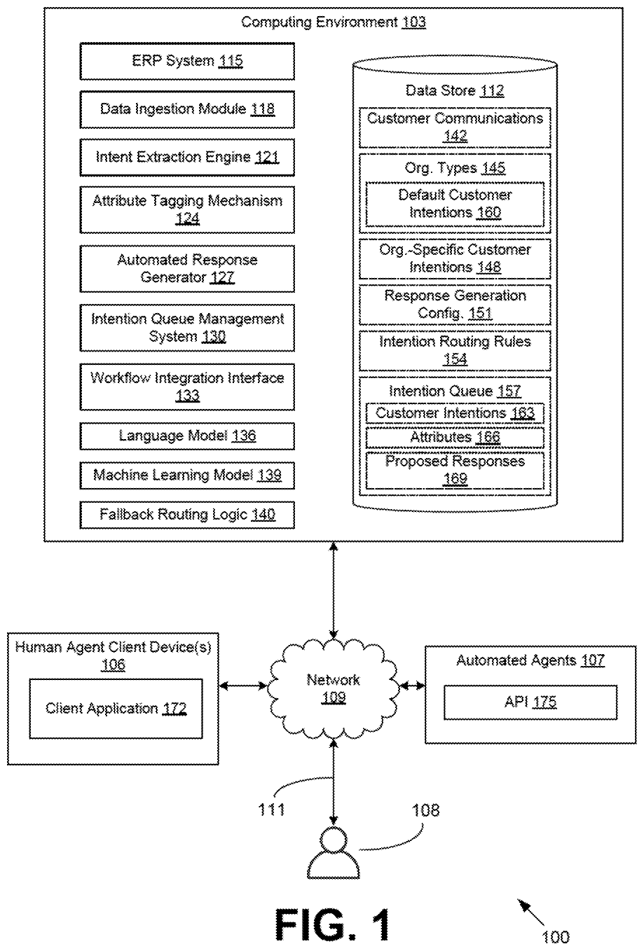

With reference to FIG. 1, shown is a networked environment 100 according to various embodiments. The networked environment 100 includes a computing environment 103, one or more human agent client devices 106, one or more automated agents 107, and one or more user systems 108, which are in data communication with each other via a network 109. The network 109 includes, for example, the Internet, intranets, extranets, wide area networks (WANs), local area networks (LANs), wired networks, wireless networks, cable networks, satellite networks, or other suitable networks, etc., or any combination of two or more such networks.

The user systems 108 may communicate with the computing environment 103 by way of one or more communication channels 111. Non-limiting examples of communication channels 111 may include email, web-based chat functionality, voice communication, text messaging services, and so on.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 112 that is accessible to the computing environment 103. The data store 112 may be representative of a plurality of data stores 112 as can be appreciated. The data stored in the data store 112, for example, is associated with the operation of the various applications and/or functional entities described below.

The components executed on the computing environment 103, for example, include an ERP system 115, a data ingestion module 118, an intent extraction engine 121, an attribute tagging mechanism 124, an automated response generator 127, an intention queue management system 130, a workflow integration interface 133, a language model 136, a machine learning model 139, fallback routing logic 140, and other applications, services, processes, systems, engines, or functionality not discussed in detail herein.

The ERP system 115 is an integrated software solution that helps organizations manage and automate core business processes across departments in a centralized system. The ERP system 115 may combine functionalities such as finance, human resources, supply chain management, manufacturing, customer relationship management (CRM), and more, ensuring seamless data flow and real-time visibility into operations. By eliminating data silos and improving efficiency, ERP systems 115 enhance decision-making, streamline workflows, and increase overall productivity. Various embodiments of ERP systems 115 are often cloud-based, scalable, and customizable to meet the specific needs of businesses in various industries.

An ERP system 115 collects and organizes vast amounts of data from different business functions, providing a comprehensive view of an organization's operations. Examples of data obtained from an ERP system 115 include financial records such as revenue, expenses, and profit margins; inventory levels detailing stock quantities, reorder points, and supplier information; customer data including purchase history, preferences, and outstanding invoices; employee records like payroll details, attendance, and performance metrics; and production data tracking manufacturing progress, machine utilization, and quality control. This ERP data enables organizations to analyze trends, optimize resources, and make data-driven decisions for improved efficiency and profitability.

The data ingestion module 118 may be configured to collect, aggregate, and process customer communications from multiple channels to ensure comprehensive data integration and accessibility. These channels may include, but are not limited to, emails, which contain textual exchanges between customers and support representatives; chat logs, capturing real-time or asynchronous digital interactions from web-based chat interfaces or messaging platforms; and transcribed voice calls, where spoken conversations are converted into machine-readable text for further processing. The data ingestion module 118 may handle structured and unstructured data, applying necessary formatting and metadata association to standardize the collected information. By consolidating customer communications from potentially disparate sources, embodiments of the data ingestion module 118 may facilitate real-time data synchronization, enabling downstream analytical processes, sentiment analysis, intent recognition, and automated response generation.

The intent extraction engine 121 may be executed to analyze incoming customer communications and accurately determine user intentions through advanced Natural Language Processing (NLP) techniques and Large Language Model (LLM) capabilities. The intent analysis functionality of the intent extraction engine 121 may process structured and unstructured data to extract customer intentions, enabling automated classification and response mechanisms. Additionally, the intent extraction engine 121 may incorporate an optional dynamic intention enhancement module, which may refine or expand the intent categorization framework over time. This module may include a learning component that continuously analyzes both historical and real-time data, identifying trends and evolving customer needs to improve intent recognition accuracy. The category derivation process further enables the intent extraction engine 121 to generate new intention categories or update existing classifications in response to emerging patterns in customer interactions. A feedback loop mechanism may ensure that enhancements and newly derived insights are iteratively incorporated back into the intent extraction engine 121, thereby fostering continuous learning and adaptive improvement. This dynamic capability allows the intent extraction engine 121 to remain responsive to shifting user behaviors, optimizing the precision of intent recognition while reducing reliance on static predefined intent categories.

The attribute tagging mechanism 124 may be configured to enhance the classification and processing of customer interactions by assigning relevant attributes to extracted intentions. The attribute tagging mechanism 124 operates in conjunction with the dynamically updated list of intentions, ensuring that attribute assignments remain adaptive to evolving customer behaviors and contextual nuances. To improve decision accuracy, the attribute tagging mechanism 124 may optionally incorporate Generative AI (GenAI) and Machine Learning (ML) models for certainty assessment, determining the confidence level of each identified intention. Based on this assessment, a decision routing process may determine whether the identified intention should be automatically processed or escalated for human intervention when confidence levels fall below a predefined threshold. Additionally, the attribute tagging mechanism 124 may support the creation of trigger conditions, which are dynamically established by evaluating responses obtained from application programming interface (API) calls. When specific trigger conditions are met, the system can autonomously generate and send complete responses to customers, streamlining interaction handling and reducing the need for manual oversight. This adaptive approach ensures precise intention categorization, optimizes workflow automation, and enhances the overall efficiency of customer communication processing.

The automated response generator 127 is configured to automatically generate and, in some cases transmit, responses following the extraction of intent from incoming communications. Once the intent extraction engine 121 identifies the customer's intention, the automated response generator 127 formulates a contextually relevant response, acknowledging receipt of the inquiry and providing updates on the corresponding actions being taken. For example, upon detecting a customer intention related to an order request or billing dispute, the automated response generator 127 may generate messages such as, “We are processing your new order” or “Your billing dispute is under review.” The automated response generator 127 may leverage Natural Language Processing (NLP) models, Generative AI (GenAI), or rule-based templates to ensure clarity, accuracy, and appropriateness of the message. Additionally, the automated response generator 127 may support personalization mechanisms, dynamically incorporating customer-specific details such as order numbers, estimated resolution times, or case references. The automated response generator 127 may incorporate customer data obtained from the ERP system 115.

The intention queue management system 130 may implement a message encapsulation and queuing mechanism to efficiently manage extracted customer intentions and customer communications for downstream processing. Each tagged intention may be encapsulated into a discrete message unit, ensuring that all relevant metadata, attributes, and confidence scores associated with the identified intention are preserved. These encapsulated message units may then be systematically organized into a structured queue, serving as the designated entry point for further processing within the system. The structured queue enables prioritized handling, sequential processing, and dynamic routing of messages based on predefined rules or real-time operational conditions. Additionally, the queuing mechanism may incorporate load-balancing strategies, ensuring optimal resource allocation by distributing processing tasks efficiently. This structured approach enhances system scalability, facilitates seamless integration with downstream workflows, and supports real-time decision-making for automated or human-assisted processing of customer interactions.

The workflow integration interface 133 may be configured to facilitate the seamless routing of encapsulated message units from the structured queue to appropriate downstream workflows for further processing. The workflow integration interface 133 may ensure that each message unit, containing a tagged intention and its associated metadata, is dynamically directed to the most suitable processing pathway. The workflow integration interface 133 supports hybrid processing capabilities, enabling both automated systems and human agents to handle messages based on the tagged attributes, certainty assessment, and predefined business logic. For high-confidence intentions, the workflow integration interface 133 may route messages directly to automated workflows, triggering predefined system actions such as order processing, ticket resolution, or status updates. Conversely, for intentions requiring manual review or decision-making, the workflow integration interface 133 can escalate the message unit to human agents via an interactive dashboard, task management, or ticketing system. Additionally, the workflow integration interface 133 may incorporate real-time monitoring and feedback loops, ensuring continuous adaptation and refinement of routing logic based on evolving operational requirements and system performance metrics.

A language model 136 is a type of artificial intelligence (AI) model that is trained on textual data to generate coherent and contextually relevant text. A “large” language model refers to a language model that has been trained on an extensive dataset and has a high number of parameters, enabling them to capture complex language patterns and perform a wider range of tasks. Large language models are designed to handle a wide range of natural language processing tasks, such as text completion, translation, summarization, and even conversation. The specific parameter count required for a model to be considered a “large” language model can vary depending on context and technological advancements. However, traditionally, large language models have millions to billions of parameters. LLMs may have the ability to understand, process, and generate text, audio, and video. For example, a language model 136 may process images such as a screenshot of a chat session. LLMs are increasingly being trained using image, audio, and video data.

Machine learning refers to a discipline by which computer systems can be trained to recognize patterns through repeated exposure to training data. The learned parameters of a machine learning model 139 can be considered as an encoding of meaningful patterns in the training data, such that the trained model can then recognize these same patterns in new data. The use of a trained model in production is often referred to as “inference,” during which the model receives new data that was not in its training data set and provides an output based on its learned parameters. In contrast to machine learning (ML), artificial intelligence (AI) refers to a human perception of a computer system as possessing a capability typically considered to require intelligence. Generative AI, or “GenAI”, refers to a class of machine learning models 139 that are able to produce net new content as their outputs, for example text, images, and video.

LLMs are typically pretrained. For specific use cases, LLMs are usually fine-tuned, which uses relevant data to refine a pretrained LLM for the specific use case. Machine learning is also an option where an LLM is trained from scratch. This may result in increased performance but is more resource intensive.

The fallback routing logic 140 is executed to handle situations where the API fails or confidence in a determination falls under a threshold. For example, the intent extraction engine 121 may fail to determine a customer intention with sufficient confidence. In such cases, the fallback routing logic 140 may be configured to perform one or more fallback actions to handle the communication. In one implementation, the communication may be escalated for immediate manual review.

The data stored in the data store 112 includes, for example, customer communications 142, one or more organization types 145, one or more organization-specific customer intentions 148, a response generation configuration 151, one or more intention routing rules 154, an intention queue 157, and potentially other data. The customer communications 142 correspond to communications between a customer and an organization. For example, the customer communications 142 may include email messages, text messages, voice recordings from telephone calls, chat transcripts, and other forms of communication. The customer communications 142 may be, for example, sales inquiries, order status inquiries, feedback regarding orders, order modifications, payment status inquiries, and other types of communications. In some embodiments, the customer communications 142 may include a customer communications history for an organization, potentially indexed by customer.

The organization types 145 may correspond to different types of organizations supported by the ERP system 115 and the computing environment 103. Non-limiting examples of organization types 145 may include manufacturing companies, retail businesses, healthcare providers, financial institutions, government agencies, educational institutions, logistics and supply chain firms, construction companies, hospitality enterprises, technology service providers, and others.

Each of the organization types 145 may be associated with default customer intentions 160, which may correspond to a default set of customer intentions that are automatically generated and/or manually curated for the organization type 145. The default customer intentions 160 may differ between different organization types 145. For example, a default customer intention 160 for a food service company may include “delivery status inquiry,” but a default customer intention 160 for a financial institution may exclude the same. Likewise, a default customer intention 160 for a financial institution may include “initiate wire transfer,” but a default customer intention 160 for a food service company may exclude the same.

The organization-specific customer intentions 148 may include a customized set of customer intentions for a specific organization. Such a customized set may be manually adjusted (e.g., based upon results of a workshop conducted with organization representatives). The customized set may also be automatically generated based upon patterns of customer communications 142 received and processed by the intent extraction engine 121. In this way, new customer intentions may emerge over time. Similarly, customer intentions may be deprecated or removed over time. In one example, a default customer intention 160 may be superseded or disabled by the organization-specific customer intentions 148.

The response generation configuration 151 may include parameters that control the generation of proposed or automated responses to customer communications 142 by the automated response generator 127. For example, the response generation configuration 151 may include natural language commands and prompts to configure how the responses are generated. The response generation configuration 151 may include templates and sample responses in some examples.

The intention routing rules 154 may control how customer communications 142 are routed to different workflows by the workflow integration interface 133. For example, the intention routing rules 154 may direct some customer communications 142 to human agents, while others may be directed to automated agents 107. The intention routing rules 154 may be manually configured and/or may be automatically generated by the language model 136 and/or the machine learning model 139.

The intention queue 157 may correspond to a queue structure containing the customer intentions 163 determined by the intent extraction engine 121 for processing. The intention queue 157 may be managed by the intention queue management system 130. The customer intentions 163 may be in association with the customer communications 142, one or more attributes 166 tagged by the attribute tagging mechanism 124, and one or more proposed responses 169 generated by the automated response generator 127. The workflow integration interface 133 may read from the intention queue 157 and remove items for processing by particular workflows according to the intention routing rules 154.

The human agent client device 106 is representative of a plurality of client devices 106 that may be coupled to the network 109. The human agent client device 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The human agent client device 106 may include a display comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The human agent client device 106 may be configured to execute various applications such as a client application 172 and/or other applications. The client application 172 may be executed in a human agent client device 106, for example, to access network content served up by the computing environment 103 and/or other servers, thereby rendering a user interface on the display. To this end, the human agent client application 172 may comprise, for example, a browser, a dedicated application, etc., and the user interface may comprise a network page, an application screen, etc. The human agent client device 106 may be configured to execute applications beyond the client application 172 such as, for example, email applications, social networking applications, word processors, spreadsheets, and/or other applications.

The automated agent 107 may be a system that executes an automated workflow based upon customer intentions 163. To this end, the automated agent 107 may include an application programming interface (API) 175 that supports various functions. The automated agent 107 may send automated response communications to the customer, undertake actions requested by the customer, and/or perform other actions responsive to the customer intentions 163.

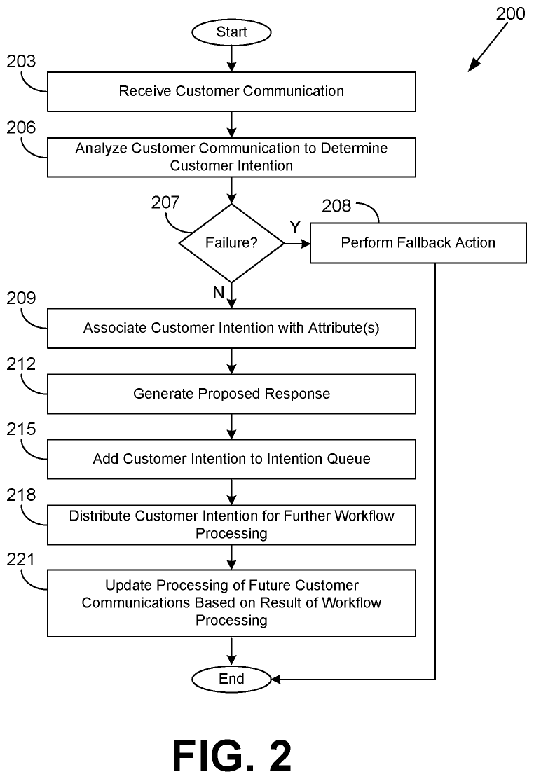

Referring next to FIG. 2, shown is a flowchart 200 that provides one example of the operation of a portion of the computing environment 103 according to various embodiments. It is understood that the flowchart 200 provides merely an example of the many different types of functional arrangements that may be employed to implement the operation of the portion of the computing environment 103 as described herein. As an alternative, the flowchart 200 may be viewed as depicting an example of elements of a method implemented in the computing environment 103 (FIG. 1) according to one or more embodiments.

Beginning with box 203, the data ingestion module 118 receives a customer communication 142. For example, a user system 108 may initiate a customer communication 142 with an organization using one or more communication channels 111, such as email, text messaging, web-based chat, telephone call, and so on. The customer communication 142 may correspond to an email message, text message, chat transcript, voice call transcript, etc. In some cases, the customer communication 142 may be received via multiple communication channels 111. For example, a customer may send an email message and then follow up with a telephone call. The data ingestion module 118 may then process and store the customer communication 142 in the data store 112.

In box 206, the intent extraction engine 121 analyzes the customer communication 142 in order to determine one or more customer intentions 163 expressed by the customer in the communication. For example, the intent extraction engine 121 may utilize a language model 136 and advanced Natural Language Processing (NLP) techniques to analyze incoming data and extract customer intentions 163. The operation of the intent extraction engine 121 may be configured based at least upon a set of possible customer intentions associated with the organization, such that the customer intentions 163 are selected from the set of possible customer intentions.

In some cases, the intent extraction engine 121 is unsuccessful in determining a customer intention 163, or any customer determination may fall beneath a required confidence level. In box 207, the fallback routing logic 140 may determine whether a failure to determine a customer intention 163 has occurred. If a failure has occurred, the fallback routing logic 140 proceeds to box 408 and performs one or more fallback actions. For example, the incoming customer communication may be immediately escalated for manual review if the customer intention 163 cannot be determined.

If a failure has not occurred in determining the customer intention 163, in box 209, the attribute tagging mechanism 124 associates the customer intention 163 with one or more attributes 166. The attribute tagging mechanism 124 may use a dynamically updated set of possible customer intentions to assign relevant attributes 166 to each identified customer intention 163. One such attribute 166 may comprise a result of a certainty assessment. The attribute tagging mechanism 124 may employ the language model 136 and/or the machine learning model 139 in order to determine a confidence level for each determined customer intention 163. Based on the result of the certainty assessment, the customer intention 163 may be routed for automated processing or may be escalated for human intervention.

In another scenario, attributes 166 may include customer data obtained from an ERP system 115 of the organization based at least in part on the determined customer intention 163 and the customer communication 142. For example, where the customer intention 163 corresponds to an order status inquiry, the ERP system 115 may be queried for the current order status, and the resulting data from the ERP system 115 (i.e., the order status) may be used in generating a proposed response or provided to a human agent to formulate a response. In some cases, the attribute tagging mechanism 124 may establish trigger conditions by evaluating responses from API calls, where complete responses are sent to customer in response to determining that trigger conditions are met. In other scenarios, trigger conditions are optionally customizable by users, where the users may manually define one or more trigger conditions.

In box 212, the automated response generator 127 may automatically generate a proposed response 169 to the customer communication 142 based at least in part on the determined customer intention 163 and/or the attributes 166. For example, the proposed response 169 may acknowledge receipt of the customer communication 142 and inform the customer of actions being taken (e.g., “We are processing your new order and your billing dispute.”). The proposed response 169 may be generated also based at least in part on the response generation configuration 151. The proposed response 169 may be a complete response that is intended to fully respond to the customer communication 142. Alternatively, the proposed response 169 may merely be an initial response to be followed up by a further response from a human agent or automated agent 107. In some scenarios, the proposed response 169 is generated based at least in part on customer data obtained by querying an ERP system 115 of the customer, where the customer data is provided to the language model 136 in order to generate the proposed response 169.

In box 215, the intention queue management system 130 adds the customer intention 163 to the intention queue 157. The customer intention 163 may be added to the intention queue 157 in association with the attributes 166, the proposed responses 169, and the customer communication 142 itself. The intention queue management system 130 may encapsulate each tagged customer intention 163 into a discrete message unit, and then organize these message units as a structured intention queue 157.

In box 218, the workflow integration interface 133 may obtain the customer intention 163 and its associated data from the intention queue 157 and then distribute it for further workflow processing. The distribution of the customer intention 163 may be configured at least in part by one or more intention routing rules 154. The further workflow processing may include automatically invoking an action (e.g., by calling an API 175 of an automated agent 107) in order to move forward with an automated function responding to the customer communication 142. For example, the proposed response 169 may be automatically sent to the customer based at least in part on a certainty assessment having a confidence level meeting a threshold.

Alternatively, or additionally, the further workflow processing may include generating a ticket for a ticketing system that is accessible by one or more human agent client devices 106 so that a manual task responding to the customer communication 142 can be performed. The ticket may be tagged with the determined customer intention 163, the attributes 166, and/or the proposed response 169. In some cases, multiple proposed responses 169 may be generated and associated with the ticket, and the human agent may select a particular response to be used from the multiple generated proposed responses 169. Ultimately, a communication may be sent back to the user system 108 to notify the customer of the response, which may include the proposed response 169 and/or a manually curated response.

In box 221, the machine learning model 139 and/or the language model 136 may update the processing of future customer communications 142 for the organization and/or other organizations based at least in part on the result of the workflow processing. For example, the intention routing rules 154, the response generation configuration 151, the default customer intentions 160, the organization-specific customer intentions 148, and/or other configuration data may be updated for processing of future customer communications 142. Thereafter, the operation of the flowchart 200 ends.

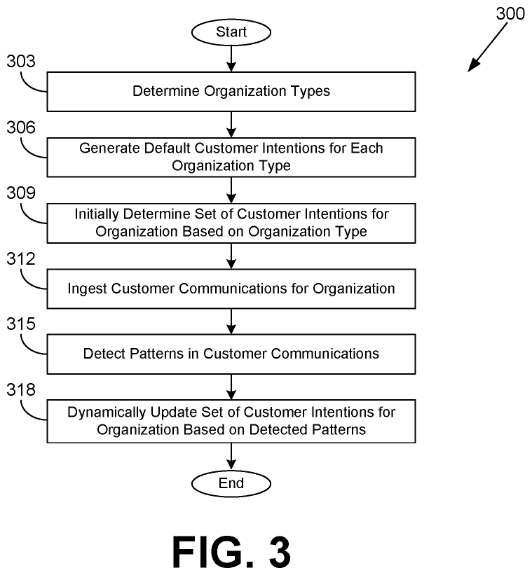

Referring next to FIG. 3, shown is a flowchart 300 that provides one example of the operation of another portion of the computing environment 103 according to various embodiments. It is understood that the flowchart 300 provides merely an example of the many different types of functional arrangements that may be employed to implement the operation of the portion of the computing environment 103 as described herein. As an alternative, the flowchart 300 may be viewed as depicting an example of elements of a method implemented in the computing environment 103 (FIG. 1) according to one or more embodiments.

Beginning with box 303, the language model 136 and/or the machine learning model 139 determines a set of organization types 145 supported by the computing environment 103 and/or the ERP system 115. In box 306, the language model 136 and/or the machine learning model 139 automatically generates a set of default customer intentions 160 for each of the organization types 145.

In box 309, the language model 136 and/or the machine learning model 139 initially determines a set of possible customer intentions for a given organization using the set of default customer intentions 160 associated with the corresponding organization type 145 of the given organization. In box 312, the data ingestion module 118 ingests customer communications 142 for the organization. In box 315, the language model 136 and/or the machine learning model 139 detects patterns in the customer communications 142 for the organization.

In box 318, the language model 136 and/or the machine learning model 139 may update the set of possible customer intentions for the organization based at least in part on the detected patterns. In some embodiments, the updates to the intention model may be performed in real-time based upon processing of incoming customer communications 142. In other embodiments, the updates may be performed in a non-real-time batch process on a periodic basis that may aggregate processing of a number of different incoming customer communications 142. Thereafter, the operation of the flowchart 300 ends.

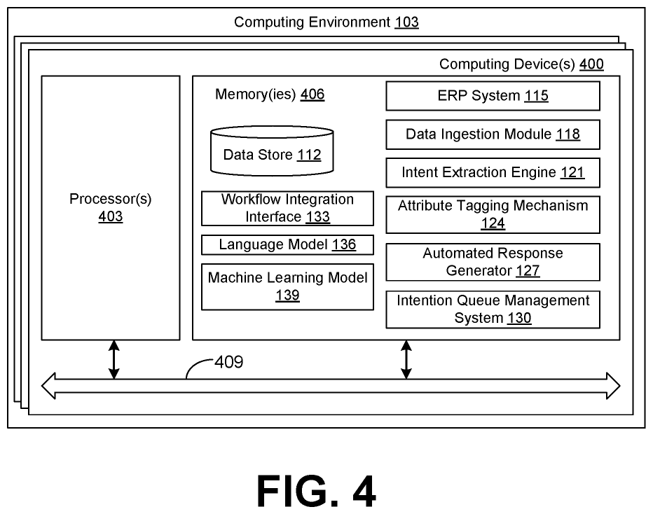

With reference to FIG. 4, shown is a schematic block diagram of the computing environment 103 according to an embodiment of the present disclosure. The computing environment 103 includes one or more computing devices 400. Each computing device 400 includes at least one processor circuit, for example, having a processor 403 and a memory 406, both of which are coupled to a local interface 409. To this end, each computing device 400 may comprise, for example, at least one server computer or like device. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are the ERP system 115, the data ingestion module 118, the intent extraction engine 121, the attribute tagging mechanism 124, the automated response generator 127, the intention queue management system 130, the workflow integration interface 133, the language model 136, the machine learning model 139, and potentially other applications. Also stored in the memory 406 may be a data store 112 and other data. In addition, an operating system may be stored in the memory 406 and executable by the processor 403.

It is understood that there may be other applications that are stored in the memory 406 and are executable by the processor 403 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, universal serial bus (USB) flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and/or multiple processor cores and the memory 406 may represent multiple memories 406 that operate in parallel processing circuits, respectively. In such a case, the local interface 409 may be an appropriate network that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although the ERP system 115, the data ingestion module 118, the intent extraction engine 121, the attribute tagging mechanism 124, the automated response generator 127, the intention queue management system 130, the workflow integration interface 133, the language model 136, the machine learning model 139, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 2 and 3 show the functionality and operation of an implementation of portions of the computing environment 103. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403 in a computer system or other system. The machine code may be converted from the source code, etc. If embodied in hardware, each block may represent a circuit or a number of interconnected circuits to implement the specified logical function(s).

Although the flowcharts of FIGS. 2 and 3 show a specific order of execution, it is understood that the order of execution may differ from that which is depicted. For example, the order of execution of two or more blocks may be scrambled relative to the order shown. Also, two or more blocks shown in succession in FIGS. 2 and 3 may be executed concurrently or with partial concurrence. Further, in some embodiments, one or more of the blocks shown in FIGS. 2 and 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the ERP system 115, the data ingestion module 118, the intent extraction engine 121, the attribute tagging mechanism 124, the automated response generator 127, the intention queue management system 130, the workflow integration interface 133, the language model 136, and the machine learning model 139, that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the ERP system 115, the data ingestion module 118, the intent extraction engine 121, the attribute tagging mechanism 124, the automated response generator 127, the intention queue management system 130, the workflow integration interface 133, the language model 136, and the machine learning model 139, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 400, or in multiple computing devices 400 in the same computing environment 103.

Unless otherwise explicitly stated, articles such as “a” or “an”, and the term “set”, should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A computer-implemented method, comprising:
receiving a customer communication;
analyzing the customer communication using a language model to determine a customer intention expressed in the customer communication, the customer intention being selected from a set of customer intentions;
associating the customer intention with one or more attributes;
generating a proposed response to the customer communication using the language model; and
adding the customer communication in association with the determined customer intention, the one or more attributes, and the proposed response to a queue for subsequent workflow processing.

2. The computer-implemented method of claim 1, wherein the one or more attributes includes a certainty assessment indicating a confidence level for the determined customer intention, and the method further comprises automatically sending the proposed response to the customer based at least in part on the certainty assessment.

3. The computer-implemented method of claim 1, wherein receiving the customer communication further comprises receiving the customer communication via a plurality of communication channels including at least two of: an email message, a text message, a chat transcript, or a telephone call.

4. The computer-implemented method of claim 1, further comprising initially determining the set of customer intentions based at least in part on a default set of customer intentions associated with an organization type.

5. The computer-implemented method of claim 1, further comprising dynamically updating the set of customer intentions by a machine learning model based at least in part on detected patterns in customer communications.

6. The computer-implemented method of claim 1, wherein the further workflow processing comprises creating a ticket for the customer communication in a ticketing system for manual response to the customer communication, the ticket being tagged with the determined customer intention, the one or more attributes, and the proposed response.

7. The computer-implemented method of claim 1, wherein the further workflow processing comprises automatically invoking an action to respond to the customer communication by an automated agent.

8. The computer-implemented method of claim 1, wherein the one or more attributes include customer data obtained from an enterprise resource planning (ERP) system based at least in part on the determined customer intention and the customer communication.

9. The computer-implemented method of claim 1, wherein the proposed response is generated based at least in part on customer data obtained from an enterprise resource planning (ERP) system based at least in part on the determined customer intention and the customer communication, the customer data being provided to the language model.

10. A system, comprising:
at least one computing device; and
instructions executable in the at least one computing device, wherein when executed the instructions cause the at least one computing device to at least:
receive a customer communication via one or more of a plurality of communication channels;
analyze the customer communication using a language model to determine a customer intention expressed in the customer communication, the customer intention being selected from a set of customer intentions;
associate the customer intention with one or more attributes; and
add the customer communication in association with the determined customer intention and the one or more attributes to a queue for subsequent workflow processing.

11. The system of claim 10, wherein the instructions further cause the at least one computing device to at least generate a proposed response to the customer communication using the language model based at least in part on customer data obtained from an enterprise resource planning (ERP) system.

12. The system of claim 10, wherein the one or more attributes includes a certainty assessment indicating a confidence level for the determined customer intention.

13. The system of claim 10, wherein the instructions further cause the at least one computing device to at least initially determine the set of customer intentions based at least in part on a default set of customer intentions associated with an organization type.

14. The system of claim 10, wherein the instructions further cause the at least one computing device to at least dynamically update the set of customer intentions by a machine learning model based at least in part on detected patterns in customer communications.

15. The system of claim 10, wherein the further workflow processing comprises creating a ticket for the customer communication in a ticketing system for manual response to the customer communication, the ticket being tagged with the determined customer intention and the one or more attributes.

16. The system of claim 10, wherein the further workflow processing comprises automatically invoking an action to respond to the customer communication by an automated agent.

17. The system of claim 10, wherein the one or more attributes include customer data obtained from an enterprise resource planning (ERP) system based at least in part on the determined customer intention and the customer communication.

18. A non-transitory computer-readable medium embodying instructions executable in at least one computing device, wherein when executed the instructions cause the at least one computing device to at least:
receive a customer communication;
analyze the customer communication using a language model to determine a customer intention expressed in the customer communication, the customer intention being selected from a set of customer intentions;
associate the customer intention with one or more attributes;
generate an initial response to the customer communication using the language model;
automatically send the initial response to a customer corresponding to the customer communication; and
add the customer communication in association with the determined customer intention and the one or more attributes to a queue for subsequent workflow processing.

19. The non-transitory computer-readable medium of claim 18, wherein the instructions further cause the at least one computing device to at least:
initially determine the set of customer intentions based at least in part on a default set of customer intentions associated with an organization type; and
dynamically update the set of customer intentions by a machine learning model based at least in part on detected patterns in customer communications.

20. The non-transitory computer-readable medium of claim 18, wherein the further workflow processing comprises creating a ticket for the customer communication in a ticketing system for manual response to the customer communication, the ticket being tagged with the determined customer intention, the one or more attributes, and the initial response.
